(19) United States
(12) Patent Application Publication
(10) Pub. No.: US 2009/0326817 A1
(43) Pub. Date: Dec. 31, 2009

(54) ELECTRONIC SYSTEM WITH SATELLITE NAVIGATION AND DISPLAY THEREOF

(76) Inventor: Chi-Hung Lin, Taipei (TW)

Correspondence Address: Dr. BANGER SHIA;Int''l Patent Office of Bang Shia, 102 Lindencrest Ct, Sugar Land, TX, 77479-5201, US

(21) Appl. No.: 12/426,161

(22) Filed: Apr. 17, 2009

(30) Foreign Application Priority Data
Jun. 25, 2008 (TW) 97123634

(51) Int. Cl. G01C 21/00

(52) U.S. Cl. 701/213

(57) ABSTRACT

An electronic system with a satellite navigation function and a display thereof are provided. The display of the electronic system is designed to be detachable and has a GPS module inside. In normal condition, the display is connected to a main body to be a common display. In another aspect, when the display is detached from the main body, the display may be used as a satellite navigation system on a vehicle independently. This makes use of the characteristic of the electronic system that the electronic system has a bigger display body. A user does not need to buy a satellite navigation system additionally, and the disadvantage that the display body of the satellite navigation system is so small that the characters are not easy to be recognized is overcome.

### BACKGROUND OF THE INVENTION

1. Field of Invention

The invention relates to an electronic system with satellite navigation and a display thereof. That is, the invention relates to an electronic device having a display body with a large size such as a notebook computer and, more particularly, to an electronic system with satellite navigation from which a display may be detached and used as a satellite navigation system independently and the display thereof.

2. Description of the Related Art

It is a trend that people like to go around for travelling on holidays. A vehicle navigation with global satellite positioning and navigation software may prevent people from getting lost on the road. Thus, it becomes a necessary object when people go out for travelling. A global positioning system (GPS) is a medium earth orbit satellite navigation system. It may provide precise location, velocity and accurate time standard in most areas of the global surface (98 percent). Cooperating with the navigation software, the GPS may provide an accurate route for a driver to prevent the driver from getting lost or detouring.

However, the volume of the current satellite navigation device is designed to be small for facilitating the carrying. Relatively, the display body may not be big. Therefore, although it is convenient for carrying or keeping, it is not convenient for the driver to operate. Especially, it is not easy to read or recognize the characters on the satellite navigation device.

The general satellite navigation device has a phonic navigation function. A driver may preset a destination and requirement (such as the shortest distance, the fastest speed and so on). Then, when the vehicle is near a crossing, the phonic navigation device indicates to the driver that he should go straight or turn. However, before the destination is set, the driver also has to operate the satellite navigation device towards the mini-sized display body, and recognizing the characters is still a big problem. In addition, the user does not have definite destination every time. In some cases, the user watches the satellite navigation device and drives meanwhile to recognize the way. At that moment, if the display body is too small, the user may go out his way, lose or detour, and more seriously, the safety of the driver when driving a vehicle is affected.

In another aspect, although a satellite navigation module is disposed in some advanced notebook to be a navigation device temporarily. However, the volume of the notebook is big, and the notebook is not convenient to dispose in front of the driver's seat. Generally, it is held by a passenger sitting beside the driver. However, there is no passenger sitting next to the driver every time. If it is put on a seat next to the driver, it is not convenient for the driver to watch. In addition, when the notebook computer is operated, the hard disc also works. It is not proper to dispose the computer on the vehicle. Once the road is uneven or the car brakes emergently, the system is easy to be down, and if it is serious, the hard disk drive may be damaged for scratch.

### BRIEF SUMMARY OF THE INVENTION

An electronic system having satellite navigation disclosed in the invention includes a main body and a display. The display is disposed on the main body to allow a user to operate normally. The display also may be detached from the body of the electronic device. The GPS module disposed inside the display allows the driver to use as a satellite navigation device. Generally, the electronic system has a larger display body, and this may conquer the problem that the display body is so small that the characters cannot be seen clearly or they are not easy to be recognized.

In another aspect, to make the user dispose and operate the display body on a vehicle easily, the invention further includes a carrying base to allow the display to be disposed on after it is detached. This facilitates the disposing of the display on the vehicle. The display body of the display further includes a connecting port and a control circuit. The connecting port is used to connect the display to the main body, and thus, an electrical connection is formed to receive signal from the main body and display the signal. Thus, the user can operate the electronic system normally. The control circuit controls to enable the GPS module after the display is detached, and this allows the user to use the GPS module separately and operate the function of the GPS module directly. The display has a battery on its own to provide power for it, and the battery also may be designed to be disposed in the carrying base. Cooperating with a vehicle charging connecting wire, the battery is charged and provides power continually.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing an electronic system having satellite navigation disclosed in the invention;

FIG. 2A and FIG. 2B are schematic diagrams showing that a display of an electronic system having satellite navigation combines with a carrying base in different embodiments of the invention;

FIG. 3A and FIG. 3B are schematic diagrams showing the appearance of an electronic system having satellite navigation disclosed in the invention;

FIG. 4 is a schematic diagram showing the bottom of a display of an electronic system having satellite navigation disclosed in the invention;

FIG. 5 is a schematic diagram showing that a display of an electronic system having satellite navigation disclosed in the invention is fixed to a main body with a screw;

FIG. 6A and FIG. 6B are schematic diagrams showing the appearance of a display of an electronic system having satellite navigation disclosed in the invention after the display is detached from a main body and assembled with a carrying base; and

FIG. 7 is a schematic diagram showing an electronic system having satellite navigation disclosed in the invention, in which a display is fixed to the carrying base with screws.

### DETAILED DESCRIPTION OF THE EMBODIMENTS

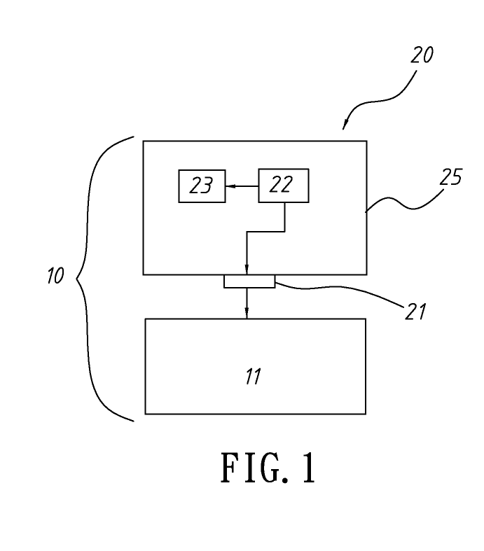

FIG. 1 is a schematic diagram showing an electronic system 10 disclosed in the invention. As shown in FIG. 1, according to the electronic system having satellite navigation disclosed in the invention, the electronic system 10 includes a main body 11 and a display 20. The display 20 further includes a display body 25 and a GPS module 23. The display body 25 further has a connecting port 21 and a control circuit 22. Generally, the electronic system 10 is just used as a common portable electronic device. The display 20 is connected to the main body 11 via the connecting port 21. The control circuit 22 controls the display 20 to display the content executed by the main body 11 and the data of the main body 11 according to a received signal to allow the user to operate the electronic system 10 normally.

Specially, a GPS module 23 is added to the display 20 and controlled by the control circuit 22. Since the main body 11 has a central processing unit (CPU), a hard disk drive (HDD) and other non-shockproof components (not shown) inside, it is not adapted for being disposed on a moving vehicle when it is operated. In addition, the main body 11 has a certain volume, and the vehicle has no proper position to dispose the main body 11. Therefore, the display 20 is designed to be detachable. In other words, the display 20 may be detached from the main body 11. After the display 20 is detached, the control circuit 22 enables the GPS module 23. Thus, the display 20 may be disposed on the vehicle separately to allow the driver to operate the display 20 directly, and the related satellite navigation function is performed. The data of the GPS module 23 is displayed through the display body 25.

Generally, the display body 25 of the electronic system 10 has no adjusting buttons, which is not similar to a desktop display. Once it is detached, there is no buttons to operate the display. Therefore, part of the display body 25 is designed to be a touch panel to meet the user's habit of operating the satellite navigation device. Therefore, even though the display body 25 is detached from the main body 11, the user also can directly operate the display body 25 on the touch panel. If the electronic system 10 has a touch pen, the user can input data with the touch pen. In another aspect, the display 20 may be designed to sense whether the connecting port 21 is connected to the main body 11 by the control circuit 22. If the display 20 is sensed to be detached from the main body 11, the control circuit 22 directly turn-on the GPS module 23. A starting button or an operation button having the satellite navigation function also may be additionally disposed on the display 20, but the manufacturing cost increases slightly.

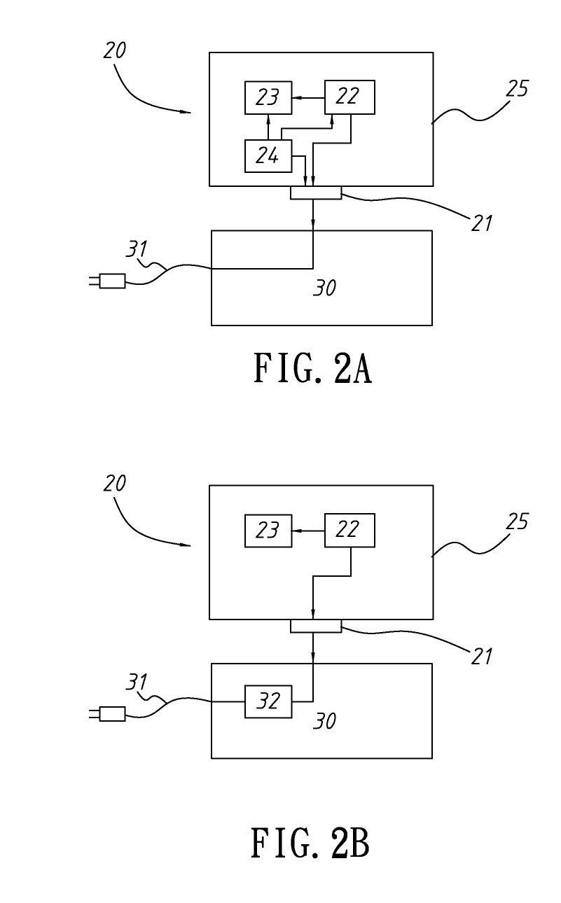

In another aspect, the display 20 of the electronic system 10 generally has a big size, and it may be used as a satellite navigation device. Therefore, when the display 20 is detached from the main body 11, it is not easy to dispose the display 20 on the vehicle separately. FIG. 2A is a schematic diagram showing the electronic system having the satellite navigation cooperating with a carrying base 30. After the display 20 is detached, it may be disposed on the carrying base 30, and then the display 20 and the carrying base 30 are both disposed in the vehicle. Therefore, the carrying base 30 needs a larger supporting area at the bottom to bear the weight of the display 20. To provide power to the GPS module 23, the display 20 further includes a battery 24. After the display 20 is detached, the GPS module 23 also may be operated. Considering that the electric quantity of the battery 24 is limited, a vehicle charging connecting wire is additionally disposed at the carrying base 30. The vehicle charging connecting wire 31 is connected to the connecting port 21 of the display 20, and the battery 24 is charged when it is used in the vehicle.

In another aspect, as shown in FIG. 2B, the power supply also may be designed to be disposed on the carrying base 30. That is, the carrying base 30 has a battery 32 on it. The connecting port 21 of the display 20 is used to provide power. The starting mode herein also may be designed to be the mode that when the control circuit 22 senses that the connecting port 21 is connected to the carrying base 30, the GPS module 23 is turn-on automatically.

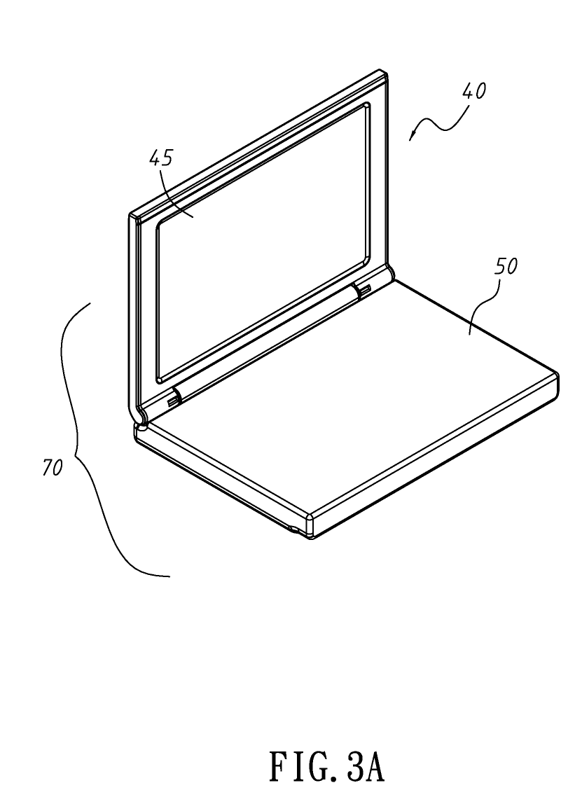

FIG. 3A and FIG. 3B are used to illustrate the external structure of the electronic system having the satellite navigation disclosed in the invention. As shown in FIG. 3A and FIG. 3B, they are schematic diagrams showing the electronic system having the satellite navigation disclosed in the invention.

The electronic system 70 includes a display 40 and a main body 50. The display 40 has a display body 45 and is disposed at the main body 50. The bottom of the display 40 has a base 42 pivotally connected to the bottom of the display body 45 of the display 40. Therefore, the display 40 may be rotated relative to the main body 50 to be open or closed. The base 42 has two tenons 41 on it, and the main body 50 has two corresponding connecting holes 51 to allow the base 42 to be inserted in the main body 50 and detached from the main body 50 easily. The control circuit, the battery and other components included in the above display 40 may be disposed inside the base 42, and they also may be disposed on other parts of the display 40.

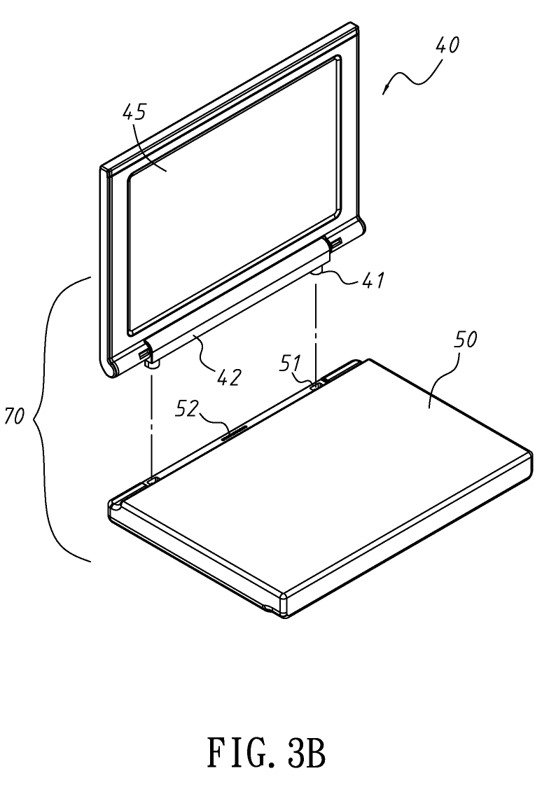

As shown in FIG. 4, the connecting port 43 of the display 40 is also disposed on the bottom of the base 42. The main body 50 has a corresponding connecting base 52 to allow the connecting port 43 to contact the connecting base 52 and electrically connected to the main body 50 to receive the signal from the main body 50. Thus, the data of the main body 50 is displayed by the display 40. Since the display 40 is designed to be detachable, to avoid the wear and damage of the connecting port 43 caused by frequent inserting and pulling, the connecting port 43 is preferably a pogo pin connector.

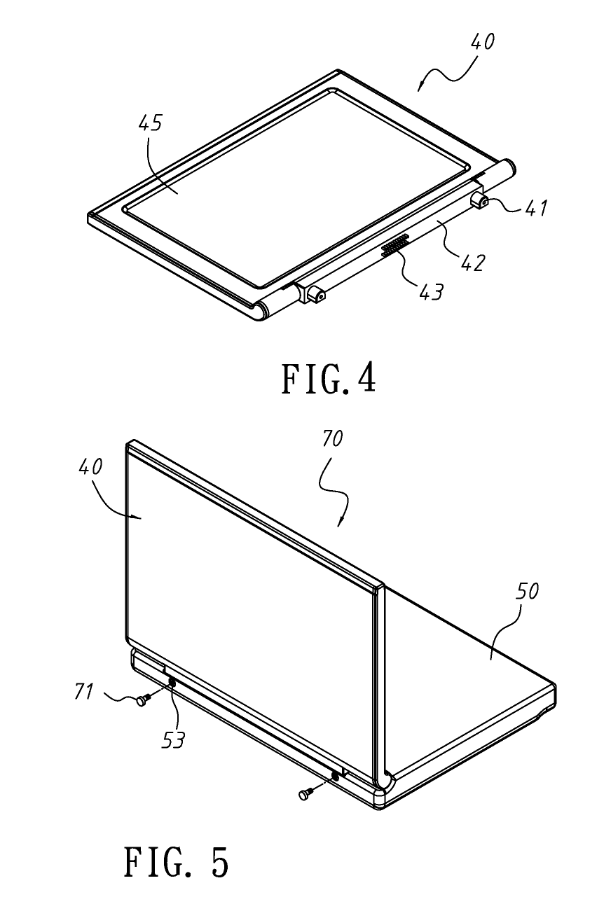

In another aspect, considering that it is not firm to insert just a tenon 41 to a connecting hole 51, a screw 71 also may be used to increase the firmness, as shown in FIG. 5. The screw 71 may be inserted in a screwed hole 53 at the back of the main body 50 to be locked with the inserted tenon 41. The screwed hole 53 communicates with the connecting hole 51. This further increases the fastening firmness. The screw 71 herein is only an embodiment, and the fixing mode may adopt other modes such as bolt fastening. The fixing mode is also an embodiment, and it is not used to limit the scope of the invention.

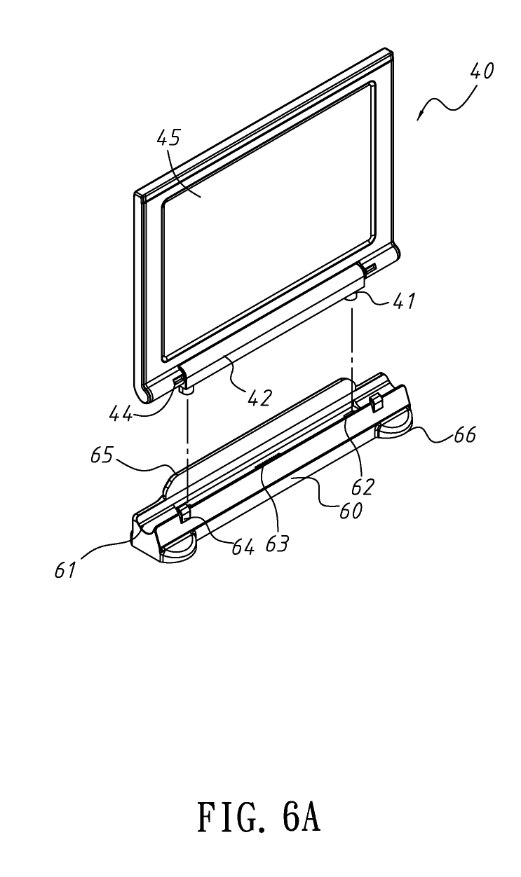

As shown in FIG. 6A and FIG. 6B, they are schematic diagrams showing the electronic system having the satellite navigation disclosed in the invention, in which the display is connected to the carrying base.

After the display 40 is detached from the main body 50, it provides related satellite navigation functions for the user independently. However, to facilitate the operation of the satellite navigation functions when the display is disposed on the vehicle, the carrying base 60 is designed to make it convenient for the user to operate the display 40 on the vehicle. The carrying base 60 has an accommodating room 61, and the accommodating room 61 is designed to cooperate with the shape of the bottom of the display 40 approximately to accommodate the bottom of the display body 45 of the display 40 properly. In addition, the accommodating room 61 has two connecting holes 62, and they are corresponding to the tenons 41 of the display 40 to allow the tenons 41 to be inserted in the connecting holes 62 to fix the display 40. However, to increase the firmness of the combination, a fastener 64 is disposed at a front edge of the accommodating room 61 of the carrying base 60. The bottom of the display 40 has a corresponding slot 44. When the tenons 41 of the display 40 are inserted in the connecting holes 62, the fastener 64 is fastened in the slot 44 at the bottom of the display 40 to increase the firmness.

In another aspect, the display 40 has a larger size, and the above connecting mode may not be enough. Especially, the display 40 is inclined to be sheet-shaped, and it is easy to rotate or overturn. Thus, an edge of the accommodating room 61 of the carrying base 60 has a protrudent block portion 65 to prevent the display 40 from rotating and being detached from the carrying base 60. Known from the embodiment above, the accommodating room 61 also may have a connecting base 63 connected to the connecting port 43 of the display 40 (as shown in FIG. 4). Since the display 40 is disposed on the vehicle, the bottom of the carrying base 60 has an extending portion 66 extending outward to increase the area of the bottom of the carrying base 60. This makes the display 40 disposed on the vehicle firmly, and the danger of overturning may be avoided when the vehicle bumps.

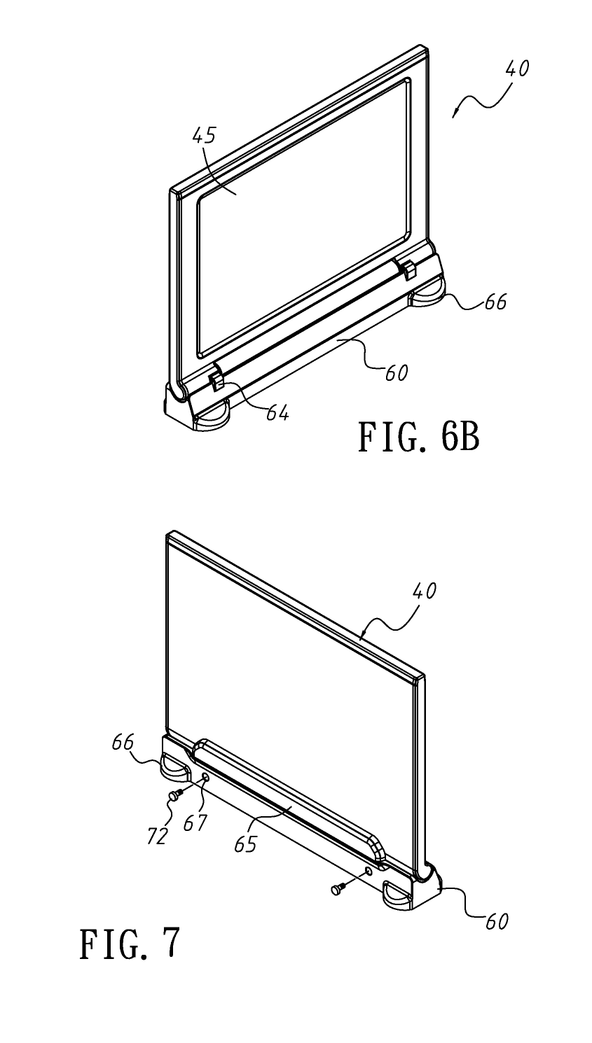

In another aspect, if the connecting mode that the tenons 41 are inserted into the connecting holes 62 cannot make the combination firm, a screw 72 may be used to increase the firmness. As shown in FIG. 7, the screw 72 may be inserted in the screwed hole 67 at the back of the accommodating room 61 of the carrying base 60 to be locked with the inserted tenon 41. The screwed hole 67 communicates with the connecting hole 62. This further increases the fastening firmness. The screw 72 herein is only an embodiment, and the fixing mode may be other modes such as bolt fastening mode which is easier to insert and pull. The fixing mode is also an embodiment, and it is not used to limit the scope of the invention.

A general ultra-mobile portable computer on the market is not convenient to process the functions such as a navigation function or a document task for it is mini in size. However, in the invention, the display may be detached from the main body to be used separately. If a user wants to process the document task, he or she may combine the display and the main body together. Thus, he or she can process general operations on the electronic device. When the user wants to use the navigation function, he or she may detach the display to use a GPS module function without worrying the damage of the components in the main body due to the uneven road. In addition, the display body is generally big in size, and this makes the image and character of the navigation system easy to be recognized.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A display adapted for an electronic system having a main body, the display comprising:
a display body having a connecting port and used to display data of the main body when the connecting port is connected to the main body; and
a Global Positioning System (GPS) module, wherein data of the GPS module is displayed by the display body when the connecting port is detached from the main body.

2. The display according to claim 1, further comprising a control circuit for controlling the enabling of the GPS module.

3. The display according to claim 2, wherein when the connecting port is detached from the main body, the control circuit enables the GPS module automatically.

4. The display according to claim 1, wherein the display body has a starting button to turn-on the GPS module.

5. The display according to claim 1, wherein the display body is a touch panel.

6. An electronic system comprising:
a main body; and
a display detachably connected to the main body, wherein the display includes:
a display body having a connecting port, wherein when the connecting port is connected to the main body, data of the main body is displayed by the display body; and
a GPS module, wherein when the connecting port is detached from the main body, data of the GPS module is displayed by the display body.

7. The electronic system according to claim 6, wherein the connecting port is a pogo pin connector.

8. The electronic system according to claim 6, further comprising a carrying base for carrying the display when the display is detached from the main body.

9. The electronic system according to claim 8, wherein the display body has a tenon to be inserted in a corresponding connecting hole of the carrying base.

10. The electronic system according to claim 8, wherein the display body has a battery for providing power to the GPS module.

11. The electronic system according to claim 10, wherein the carrying base has a vehicle charging connecting wire to be inserted in a vehicle and charge the battery.

12. The electronic system according to claim 8, wherein the carrying base has an accommodating room for accommodating a bottom of the display.

13. The electronic system according to claim 12, wherein an edge of the accommodating room of the carrying base has a protrudent block portion to prevent the display body from rotating and separating from the carrying base.

14. The electronic system according to claim 12, wherein an edge of the accommodating room of the carrying base has a fastener to be fastened to the bottom of the display body and fix the display body.

15. The electronic system according to claim 8, wherein the carrying base includes a battery for providing power to the GPS module.

16. The electronic system according to claim 15, wherein the carrying base further comprises a vehicle charging connecting wire to be inserted in a vehicle and charge the battery.

17. The electronic system according to claim 6, further comprising a control circuit for controlling the enabling of the GPS module.

18. The electronic system according to claim 17, wherein when the control circuit senses that the connecting port is detached from the main body and enables the GPS module automatically.

19. The electronic system according to claim 6, wherein the display has a starting button to turn-on the GPS module.

20. The electronic system according to claim 6, wherein the display body is a touch panel.
